(19) United States
(12) Patent Application Publication
(10) Pub. No.: US 2022/0320536 A1
(43) Pub. Date: Oct. 6, 2022

(54) FUEL CELL SYSTEM AND DRIVING METHOD THEREFOR

(71) Applicant: HONDA MOTOR CO., LTD., Tokyo (JP)

(72) Inventors: Naoki YAMANO, Saitama (JP); Tadashi NOMURA, Saitama (JP); Takashi YANAGIURA, Saitama (JP)

(21) Appl. No.: 17/676,243

(22) Filed: Feb. 21, 2022

(30) Foreign Application Priority Data
Mar. 30, 2021 (JP) 2021-056484

(51) Int. Cl. H01M 8/04119; H01M 8/04858; H01M 8/04302

(52) U.S. Cl. CPC H01M 8/04119; H01M 8/0494; H01M 8/04302

(57) ABSTRACT

There is provided a fuel cell system which can be started quickly, the configuration of which can be simplified and which enables cost reduction. The fuel cell system is a fuel cell system including a first power supply organizer, the first power supply organizer including a plurality of fuel cell stacks, an oxidant gas channel distributing and supplying oxidant gas to each of the fuel cell stacks, and an air supplier provided for each of the fuel cell stacks, wherein a battery is electrically connected to at least the air supplier of a fuel cell stack connected to the oxidant gas channel on a most upstream side among the plurality of fuel cell stacks.

This application is based on and claims the benefit of priority from Japanese Patent Application No. 2021-056484, filed on 30 Mar. 2021, the content of which is incorporated herein by reference.

### BACKGROUND OF THE INVENTION

### Field of the Invention

The present invention relates to a fuel cell system and a driving method therefor.

### Related Art

Conventionally, a fuel cell system using fuel cells has been known. The fuel cell system is configured with a fuel cell stack having a stack structure in which, for example, dozens to hundreds of cells are stacked. When hydrogen gas as reaction gas is supplied to an anode electrode of the fuel cell stack, and air including oxygen as reaction gas is supplied to a cathode electrode, power generation is performed due to electrochemical reaction.

In the case of using a fuel cell system, for example, as an emergency power generation system, it is required for the system to start quickly. As a technology related to startability of a fuel cell system, for example, a technology is known in which, in a fuel cell power generator provided with a plurality of fuel cells with large and small different capacities, a small-capacity fuel cell is provided with a burner for causing hydrogen to burn so that warm-up operation is performed using combustion gas to shorten system startup time during cold start (see, for example, Patent Document 1).
Patent Document 1: Japanese Unexamined Patent Application, Publication No. 2004-39524

### SUMMARY OF THE INVENTION

Since the technology disclosed in Patent Document 1 requires a burner for warm-up operation, the configuration of the system is complicated. Further, in the case of configuring a fuel cell system with a plurality of fuel cells, it is not necessarily in line with needs to configure the fuel cell system with fuel cells having different capacities.

The present invention has been made in view of the above, and an object is to provide a fuel cell system which can be started quickly, the configuration of which can be simplified and which enables cost reduction.

(1) The present invention relates to a fuel cell system including a first power supply organizer (for example, a first power supply system G1 to be described later), the first power supply organizer including a plurality of fuel cell stacks, an oxidant gas channel distributing and supplying oxidant gas to each of the fuel cell stacks, and an air supplier provided for each of the fuel cell stacks, wherein a battery is electrically connected to at least the air supplier of a fuel cell stack connected to the oxidant gas channel on a most upstream side among the plurality of fuel cell stacks.

According to the invention of (1), it is possible to provide a fuel cell system which can be started quickly, the configuration of which can be simplified and which enables cost reduction.

(2) The fuel cell system according to (1), further including a second power supply organizer (for example, a second power supply system G2 to be described later) having a configuration similar to the configuration of the first power supply organizer, wherein the battery is electrically connected to at least an air supplier of a fuel cell stack connected to an oxidant gas channel on a most upstream side among a plurality of fuel cell stacks constituting the second power supply organizer.

According to the invention of (2), it is possible to start a plurality of power supply systems with a single battery and simplify the configuration of the system.

(3) The fuel cell system according to (1), further including a hydrogen gas channel supplying hydrogen gas to each of the fuel cell stacks, wherein the fuel cell stack connected to the oxidant gas channel on the most upstream side is a fuel cell stack connected to the hydrogen gas channel on a most upstream side; and, between the fuel cell stack connected to the hydrogen gas channel on the most upstream side and other fuel cell stacks, a first on-off valve capable of opening and blocking the hydrogen gas channel is provided.

According to the invention of (3), it is possible to start up the fuel cell system more quickly.

(4) The fuel cell system according to (3), further including a second power supply organizer having a configuration similar to the configuration of the first power supply organizer, wherein the hydrogen gas channel is provided with a distributor distributing the hydrogen gas to the first power supply organizer and the second power supply organizer; and, on a downstream side of the distributor of the hydrogen gas channel and on an upstream side of a fuel cell stack connected to the hydrogen gas channel on the most upstream side in the second power supply organizer, a second on-off valve capable of opening and blocking the hydrogen gas channel is provided.

According to the invention of (4), it is possible to start up the fuel cell system more quickly.

(5) The fuel cell system according to (3), further including a second power supply organizer having a configuration similar to the configuration of the first power supply organizer, wherein, between the fuel cell stack located on the most upstream side of the hydrogen gas channel and the other fuel cell stacks in the first power supply organizer and between a fuel cell stack located on the most upstream side of the hydrogen gas channel and other fuel cell stacks in the second power supply organizer, first on-off valves capable of opening and blocking the hydrogen gas channel are provided, respectively.

According to the invention of (5), it is possible to start up the fuel cell system more quickly.

(6) A driving method for the fuel cell system according to (1) or (2), the driving method including: starting up the fuel cell stack connected to the oxidant gas channel on the most upstream side using the battery; and supplying power obtained by power generation of the fuel cell stack to the air suppliers of other fuel cell stacks of the fuel cell system to cause the other fuel cell stacks to start up.

According to the invention of (6), it is possible to simplify the configuration of the fuel cell system.

(7) A driving method for the fuel cell system according to (2), the driving method including: starting up the fuel cell stack connected to the oxidant gas channel on the most upstream side in the first power supply organizer using the battery and supplying power obtained by power generation of the fuel cell stack to the air supplier of the fuel cell stack connected to the oxidant gas channel on the most upstream side among the fuel cell stacks constituting the second power supply organizer to cause the fuel cell stack to start up.

According to the invention of (7), it is possible to start a plurality of power supply systems with a single battery and simplify the configuration of the system.

A driving method for the fuel cell system according to (1) or (2), the fuel cell system including a stack information acquirer acquiring fuel cell stack information including deterioration degree information about and/or an operation history of each of the fuel cell stacks,

the battery being electrically connected to the air suppliers provided for at least two or more of the fuel cell stacks, and the driving method including determining fuel cell stacks to be supplied with power from the battery, based on the deterioration degree information and/or the operation history acquired by the stack information acquirer.

According to the invention of (8), it is possible to equalize deterioration states of the fuel cell system and improve durability of the fuel cell system. Further, it is possible to cause the fuel cell system to start up quickly.

(9) A driving method for the fuel cell system according to (3), the fuel cell system including a startup preparation information acquirer acquiring startup preparation completion information about the fuel cell stack connected to the oxidant gas channel on the most upstream side, and the driving method including switching the first on-off valve from a blocked state to an open state of the hydrogen gas channel by acquiring the startup preparation completion information.

According to the invention of (9), it is possible to, after starting up one fuel cell stack, cause other fuel cell stacks to start up quickly.

(10) A driving method for the fuel cell system according to (3), the fuel cell system including a power generation amount acquirer acquiring an amount of power generation of the fuel cell stack connected to the oxidant gas channel on the most upstream side, and the driving method including switching the first on-off valve from a blocked state to an open state of the hydrogen gas channel when the amount of power generation satisfies a predetermined condition.

According to the invention of (10), it is possible to, after starting up one fuel cell stack, cause other fuel cell stacks to start up quickly.

(11) A driving method for the fuel cell system according to (4), the fuel cell system including a startup preparation information acquirer acquiring startup preparation completion information about the first power supply organizer, and the driving method including switching the second on-off valve from a blocked state to an open state of the hydrogen gas channel by acquiring the startup preparation completion information.

According to the invention of (11), it is possible to start up the fuel cell system more quickly, and it is possible to, after starting up one fuel cell stack, cause other fuel cell stacks to start up quickly.

### BRIEF DESCRIPTION OF THE DRAWINGS

FIG. 1 is a diagram showing a configuration of a fuel cell system according to a first embodiment of the present invention;

FIG. 2 is a diagram showing a configuration of a fuel cell system according to a second embodiment of the present invention; and

FIG. 3 is a diagram showing a configuration of a fuel cell system according to a third embodiment of the present invention.

### DETAILED DESCRIPTION OF THE INVENTION

Embodiments of the present invention will be described below with reference to drawings. The present invention is not limited to the embodiments below at all but can be appropriately changed and practiced within a range of the object of the present invention.

### First Embodiment

### <Fuel Cell System>

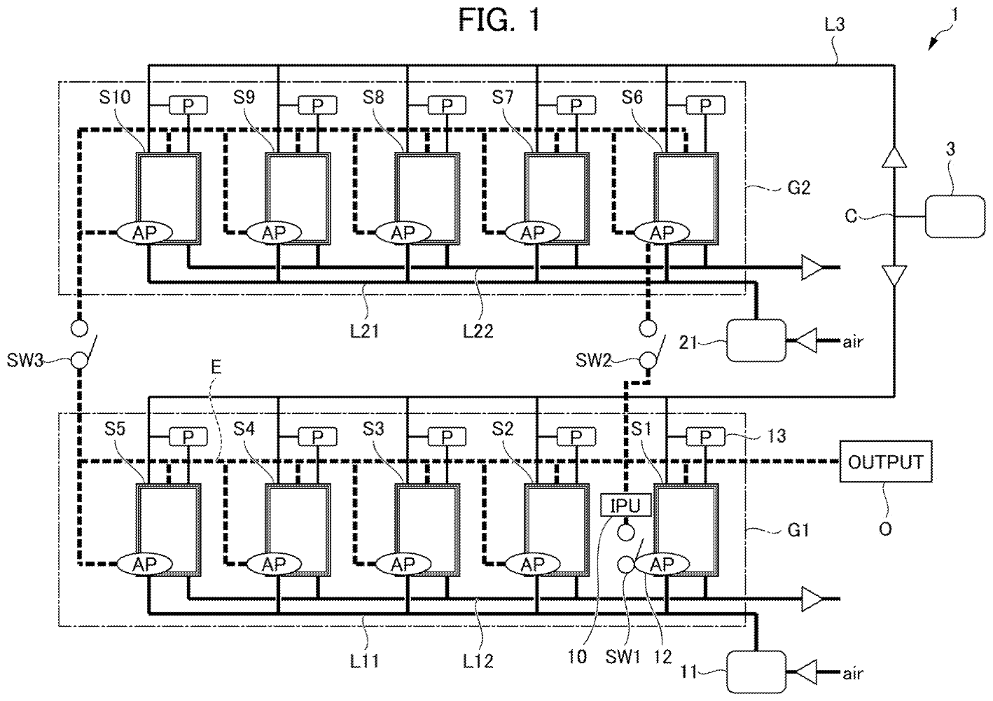

FIG. 1 is a diagram schematically showing a configuration of a fuel cell system according to the present embodiment. A fuel cell system 1 according to the present embodiment is configured with a first power supply system G1, a second power supply system G2 and a hydrogen accumulator tank 3. The number of power supply systems constituting the fuel cell system 1 is not especially limited, and there may be three or more power supply systems.

### (First Power Supply System and Second Power Supply System)

### (Fuel Cell Stacks)

The first power supply system G1 and the second power supply system G2 are configured having a plurality of fuel cell stacks S1 to S5, and S6 to S10, respectively. The number of fuel cell stacks constituting each power supply system is not especially limited to the above. A configuration of each fuel cell stack is not especially limited. For example, each fuel cell stack has a stack structure in which dozens to hundreds of cells are stacked. Each fuel cell is configured by sandwiching a membrane electrode structure (MEA) by separators. The membrane electrode structure is configured, for example, with two electrodes of an anode electrode (a negative pole) and a cathode electrode (a positive pole) and a solid polyelectrolyte membrane sandwiched by these electrodes.

When hydrogen gas is supplied to an anode channel formed on the anode electrode side, and air including oxygen as oxidant gas is supplied to a cathode channel formed on the cathode electrode side, power is generated by electrochemical reaction of these. The generated power is outputted to an external load O.

### [Oxidant Gas Channel]

The first power supply system G1 and the second power supply system G2 have supply conduits L11 and L21, respectively, and discharge conduits L12 and L22 from which oxidant gas is discharged, respectively, the supply conduits L11 and L21 being oxidant gas channels for distributing and supplying oxidant gas to the plurality of fuel cell stacks constituting the power supply systems. In the present embodiment, each of the supply conduits L11 and L21 and the discharge conduits L12 and L22 is an independent channel. As shown in FIG. 1, each of the supply conduits L11 and L21 and the discharge conduits L12 and L22 described above have a tournament structure in which channels communicating with a plurality of fuel cell stacks are integrated. The oxidant gas is supplied to the fuel cell stacks through the supply conduits L11 and L21 by air pumps (APs) which are air suppliers provided for the fuel cell stacks. The oxidant gas used for electrochemical reaction in the fuel cell stacks is discharged to the outside through the discharge conduits L12 and L22. On the upstream sides of the supply conduits L11 and L21, air purifiers 11 and 21 may be provided, respectively.

An IPU 10 as a battery is electrically connected to at least an air pump 12 of the fuel cell stack S1 connected to the supply conduit L11, which is an oxidant gas channel, on the most upstream side among the plurality of fuel cell stacks constituting the first power supply system G1. By causing a switch SW1 provided between the IPU 10 and the air pump 12 to operate, power can be supplied from the IPU 10 to the air pump 12. Thereby, by configuring the IPU 10 to be capable of supplying power to the air pump 12 of the fuel cell stack S1 to which oxidant gas flows the earliest, the fuel cell system 1 can be started up quickly. As shown in FIG. 1, the IPU 10 or the fuel cell stack S1 may be capable of supplying power via a switch SW2 to the air pump of the fuel cell stack S6 connected to the supply conduit L21, which is an oxidant gas channel, on the most upstream side among the plurality of fuel cell stacks constituting the second power supply system G2. Thereby, it is possible to cause the second power supply system G2 to start up using power generated by the IPU 10 or the fuel cell stack S1.

The fuel cell stack S1 the other fuel cell stacks S2 to 35 constituting the first power supply system G1, and the air pumps provided therefor are electrically connected via an electrical circuit E indicated by broken lines in FIG. 1. Thereby, power generated by the fuel cell stack S1 can be supplied to the air pumps provided for the other fuel cell stacks S2 to S5. Thereby, the necessity of providing an IPU for each fuel cell stack is eliminated, and the configuration of the system can be simplified. Similarly, the fuel cell stack S6, the other fuel cell stacks S7 to S10 constituting the second power supply system G2, and the air pumps provided therefor may be electrically connected.

The fuel cell stacks S1 to S5 constituting the first power supply system G1, the fuel cell stacks S6 to S10 constituting the second power supply system G2, and the air pumps provided therefor may be electrically connected via a switch SW3 as shown in FIG. 1. Thereby, such a driving method that, after causing each of the fuel cell stacks constituting the first power supply system G1 to start up, each of the fuel cell stacks constituting the second power supply system G2 is started up becomes possible.

### [Hydrogen Gas Channel]

The first power supply system G1 and the second power supply system G2 have a hydrogen gas channel L3 that distributes and supplies hydrogen gas to the plurality of fuel cell stacks constituting the power supply systems. In the present embodiment, the hydrogen gas channel L3 has a distributor C and is a common channel that supplies hydrogen gas to the first power supply system G1 and the second power supply system G2. As shown in FIG. 1, the hydrogen gas channel L3 has a tournament structure in which channels communicating with a plurality of fuel cell stacks are integrated. The hydrogen accumulator tank 3 is connected to the upstream side of the hydrogen gas channel L3. Hydrogen gas supplied from the hydrogen accumulator tank 3 to the fuel cell stacks is supplied to the fuel cell stacks by pumps 13 provided for the fuel cell stacks.

It is preferable that the fuel cell stack S1 connected to the supply conduit L11, which is an oxidant gas channel, on the most upstream side among the plurality of fuel cell stacks constituting the first power supply system G1 is also a fuel cell stack connected to the hydrogen gas channel L3 on the most upstream side. That is, it is preferable that oxidant gas and hydrogen gas are supplied earliest to the fuel cell stack 31 which is one of the plurality of fuel cell stacks constituting the first power supply system G1.

In addition to the above, the fuel cell system 1 may have a stack information acquirer for acquiring fuel cell stack information including deterioration degree information about and/or an operation history of each of the fuel cell stacks. Further, the fuel cell system 1 may have a startup preparation information acquirer for acquiring startup preparation completion information about the fuel cell stack S1 connected to the oxidant gas channel on the most upstream side. The startup preparation completion information is obtained, for example, by providing the fuel cell stack S1 with a hydrogen concentration sensor and measuring or estimating the hydrogen concentration in the fuel cells. Further, the fuel cell system 1 may have a power generation amount acquirer for acquiring the amount of power generation of the fuel cell stack S1.

### <Driving Method for Fuel Cell System>

A driving method for the fuel cell system 1 is as follows. Power is supplied from the IPU 10 to the air pump 12 of the fuel cell stack S1, and oxidant gas and hydrogen gas are supplied into the fuel cell stack S1, the hydrogen gas being supplied via the hydrogen gas channel L3, so that the fuel cell stack S1 is started up preferentially and quickly. Next, power obtained by power generation of the fuel cell stack S1 is supplied to the air pumps of the other fuel cell stacks S2 to S5 to cause the other fuel cell stack S2 to S5 to start up. Thereby, it is possible to cause the fuel cell system 1 to start up quickly and, after that, determine the number of fuel cell stacks to be started up according to power required.

The driving method for the fuel cell system 1 may be such that, after causing the fuel cell stack S1 to start up, power generated by power generation of the fuel cell stack S1 is supplied to the air pump of the fuel cell stack S6 connected to the supply conduit 121, which is an oxidant gas channel, on the most upstream side among the plurality of fuel cell stacks constituting the second power supply system G2 to cause the fuel cell stack S6 to start up. Further, after causing the fuel cell stack S6 to start up, power generated by power generation of the fuel cell stack S6 may be supplied to the air pumps of the other fuel cell stacks S7 to S10 constituting the second power supply system G2 to cause the other fuel cell stacks S7 to S10 to start up. Or alternatively, after causing the first power supply system G1 to start up, each of the fuel cell stacks constituting the second power supply system G2 may be caused to start up using power obtained by power generation of the first power supply system G1. Thereby, it is possible to determine the number of fuel cell stacks to be started up according to power required.

### Second Embodiment

### <Fuel Cell System>

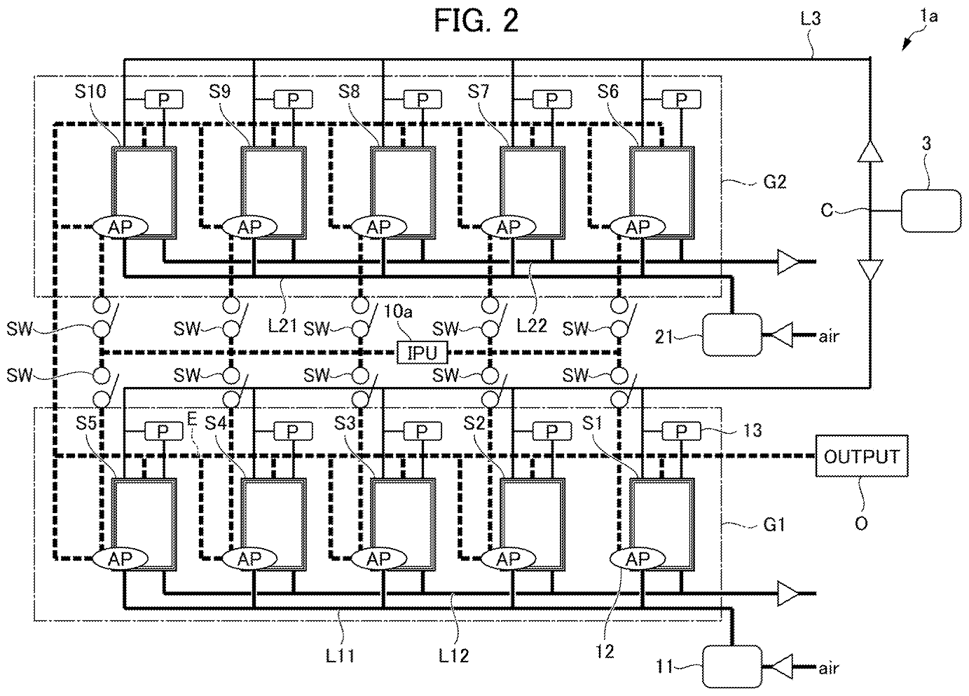

Next, a fuel cell system 1a according to a second embodiment will be described using FIG. 2 schematically showing a configuration of the fuel cell system 1a Note that, in the description below, components similar to those of the first embodiment will be given the same reference signs in the drawing, and description thereof may be omitted.

### [Battery (IPU)]

As shown in FIG. 2, an IPU 10a as a battery is electrically connected to each of the air pumps of the plurality of fuel cell stacks S1 to S5 constituting the first power supply system G1 and the fuel cell stacks S6 to S10 constituting the second power supply system G2. Though the IPU 10a is only required to be connected to two or more of the air pumps, it is preferable that the IPU 10a is connected to the air pumps of all the fuel cell stacks. By causing a switch SW provided between the IPU 10a and each air pump to operate, power can be supplied from the IPU 10a to each air pump. It is preferable that the fuel cell system 1a has the stack information acquirer (not shown) for acquiring fuel cell stack information including deterioration degree information about and/or an operation history of each of the fuel cell stacks.

### <Driving Method for Fuel Cell System>

A driving method for the fuel cell system 1a is such that priority order of the fuel cell stacks to be supplied with power from the IPU 10a is determined based on pieces of deterioration degree information and/or operation histories acquired by the stack information acquirer. Specifically, the pieces of deterioration degree information about and/or the operation histories of the fuel cell stacks are compared, for example, based on total power generation time of each of the fuel cell stacks stored in a storage in advance, and the priority order of the fuel cell stacks to be supplied with power from the IPU 10a is determined in order with a fuel cell stack with the lowest deterioration degree first. Thereby, it is possible to equalize the deterioration degrees of the fuel cell stacks, and durability of the fuel cell system 1 can be improved. In addition to the above, the fuel cell stack with the highest deterioration degree may be set as a fuel cell stack with the highest priority of being supplied with power from the IPU 10a. Thereby, it is possible to cause the startup time of the fuel cell system 1 to be the shortest.

### Third Embodiment

### <Fuel Cell System>

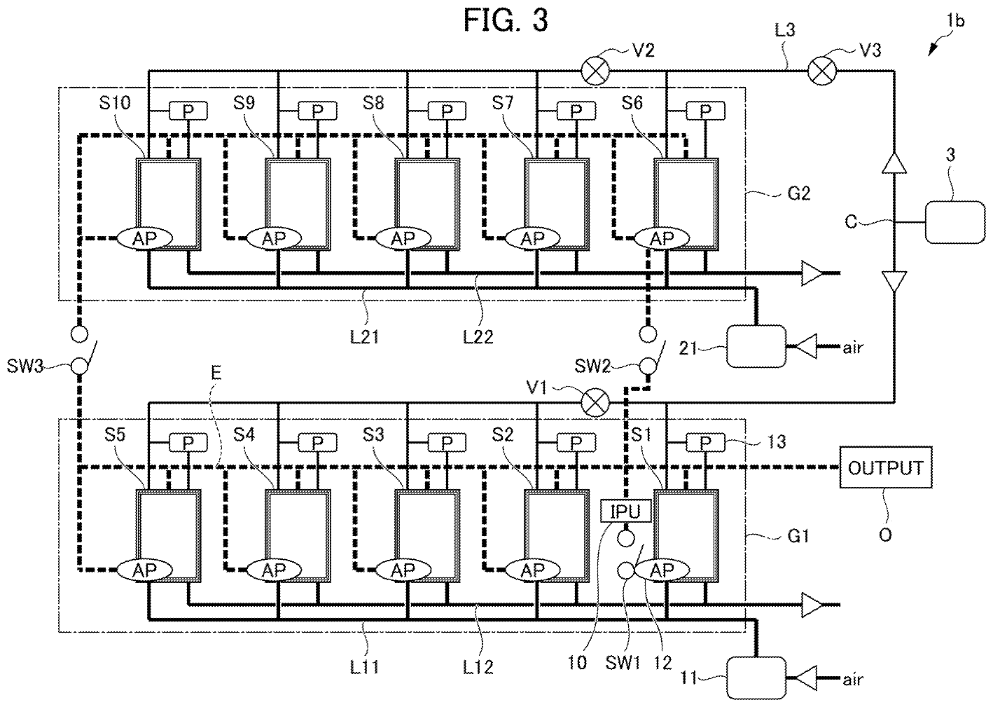

Next, a fuel cell system 1b according to a third embodiment will be described using FIG. 3 schematically showing a configuration of the fuel cell system 1b.

### [Hydrogen Gas Channel]

The hydrogen gas channel L3 according to the present embodiment is provided with a first on-off valve V1 capable of opening and blocking the hydrogen gas channel L3, between the fuel cell stack S1 connected to the hydrogen gas channel L3 on the most upstream side in the first power supply system G1 and the other fuel cell stacks S2 to S5. Similarly, a first on-off valve V2 capable of opening and blocking the hydrogen gas channel L3 is provided between the fuel cell stack S6 connected to the hydrogen gas channel L3 on the most upstream side in the second power supply system G2 and the other fuel cell stacks S7 to S10.

In addition to the above, the hydrogen gas channel L3 according to the present embodiment is provided with a second on-off valve V3 capable of opening and blocking the hydrogen gas channel L3, on the downstream side of the distributor C of the hydrogen gas channel L3 and on the upstream side of the fuel cell stack S6 connected to the hydrogen gas channel L3 on the most upstream side in the second power supply system G2.

The configuration of the first on-off valves V1 and V2 and the second on-off valve V3 according to the present embodiment is not limited to the hydrogen gas channel L3. A similar configuration of first on-off valves and a second on-off valve is also applicable to the supply conduits L11 and L21, which are oxidant gas channels, and a refrigerant channel through which a refrigerant to cool the fuel cell stacks circulates. Each of the oxidant gas channels and the refrigerant channel described above has a tournament structure in which channels communicating with a plurality of fuel cell stacks are integrated similarly to the hydrogen gas channel L3.

It is preferable that the fuel cell system 1b has at least any of the startup preparation information acquirer (not shown) for acquiring startup preparation completion information about the fuel cell stack S1 connected to the oxidant gas channel on the most upstream side and the power generation amount acquirer (not shown) for acquiring the amount of power generation of the fuel cell stack S1.

### <Driving Method for Fuel Cell System>

A driving method for the fuel cell system 1b is as follows. Power is supplied from the IPU 10 to the air pump 12 of the fuel cell stack S1 Oxidant gas is supplied into the fuel cell stack S1, and hydrogen gas is supplied into the fuel cell stack S1 via the hydrogen gas channel L3 in a state of the first on-off valves V1 and V2 and the second on-off valve V3 being blocked, so that the fuel cell stack S1 is started up preferentially. Thereby, supply of hydrogen gas to the other fuel cell stacks is stopped, and hydrogen gas is filled quickly by the hydrogen gas channel L3 leading to the fuel cell stack S1 Therefore, it is possible to start up the fuel cell stack S1 more quickly.

The driving method for the fuel cell system 1b is such that, after causing the fuel cell stack S1 to start up, the first on-off valve V1 is switched from the blocked state to the open state based on at least any of the startup preparation completion information obtained by the startup preparation information acquirer and the amount of power generation of the fuel cell stack S1 obtained by the power generation amount acquirer. Specifically, if a predetermined condition is satisfied, for example, if the hydrogen concentration in the fuel cells or the amount of power generation of the fuel cell stack S1 exceeds a threshold determined in advance, the first on-off valve V1 is switched from the blocked state to the open state. Then, hydrogen gas is supplied to the other fuel cell stacks S2 to S5 via the hydrogen gas channel L3. Thereby, it becomes possible to cause the other fuel cell stacks S2 to S5 to start up quickly after causing the fuel cell stack S1 to start up.

In the driving method for the fuel cell system 1b, in addition to the above, the condition for switching the first on-off valve V1 from the blocked state to the open state may be applied to the second on-off valve V3. Thereby, it is possible to cause the fuel cell stack S6 in the second power supply system G2 to start up quickly after causing the fuel cell stack S1 to start up. Furthermore, after that, the startup state of the fuel cell stack S6 may be confirmed based on information such as the amount of power generation to switch the first on-off valves V1 and V2 from the blocked state to the open state. Thereby, it becomes possible to cause the fuel cell stacks other than the fuel cell stacks S1 and S6 to start up quickly.

When first on-off valves and a second on-off valve are provided for each of the oxidant gas channels and the refrigerant channel, the first on-off valves and the second on-off valve provided for each of the oxidant gas channels and the refrigerant channel may be caused to operate at the same timing as the first on-off valves V1 and V2 and the second on-off valve V3 of the hydrogen gas channel L3 or may be caused to operate separately. For example, it is also possible to cause the first and second on-off valves to operate so that hydrogen flows through the hydrogen gas channel L3 before the oxidant gas and the refrigerant flow through the oxidant gas channels and the refrigerant channel.

The preferred embodiments of the present invention have been described above. However, the present invention is not limited to the above embodiments but can be appropriately changed. For example, the configuration of the hydrogen gas channel L3 having the first on-off valves V1 and V2 and the second on-off valve V3 according to the third embodiment may be combined with the fuel cell system 1a according to the second embodiment.

### EXPLANATION OF REFERENCE NUMERALS

1, 1a, 1b Fuel cell system
10, 10a IPU (battery)
12 Air pump (air supplier)
S1 to S10 Fuel cell stack
L11, L21 Supply conduit (oxidant gas channel)
L3 Hydrogen gas channel
G1 First power supply system
G2 Second power supply system
V1, V2 First on-off valve
V3 Second on-off valve

What is claimed is:

1. A fuel cell system comprising a first power supply organizer, the first power supply organizer comprising a plurality of fuel cell stacks, an oxidant gas channel distributing and supplying oxidant gas to each of the fuel cell stacks, and an air supplier provided for each of the fuel cell stacks, wherein
a battery is electrically connected to at least the air supplier of a fuel cell stack connected to the oxidant gas channel on a most upstream side among the plurality of fuel cell stacks.

2. The fuel cell system according to claim 1, further comprising a second power supply organizer having a configuration similar to the configuration of the first power supply organizer, wherein
the battery is electrically connected to at least an air supplier of a fuel cell stack connected to an oxidant gas channel on a most upstream side among a plurality of fuel cell stacks constituting the second power supply organizer.

3. The fuel cell system according to claim 1, further comprising a hydrogen gas channel supplying hydrogen gas to each of the fuel cell stacks, wherein
the fuel cell stack connected to the oxidant gas channel on the most upstream side is a fuel cell stack connected to the hydrogen gas channel on a most upstream side; and
between the fuel cell stack connected to the hydrogen gas channel on the most upstream side and other fuel cell stacks, a first on-off valve capable of opening and blocking the hydrogen gas channel is provided.

4. The fuel cell system according to claim 3, further comprising a second power supply organizer having a configuration similar to the configuration of the first power supply organizer, wherein
the hydrogen gas channel is provided with a distributor distributing the hydrogen gas to the first power supply organizer and the second power supply organizer; and
on a downstream side of the distributor of the hydrogen gas channel and on an upstream side of a fuel cell stack connected to the hydrogen gas channel on the most upstream side in the second power supply organizer, a second on-off valve capable of opening and blocking the hydrogen gas channel is provided.

5. The fuel cell system according to claim 3, further comprising a second power supply organizer having a configuration similar to the configuration of the first power supply organizer, wherein
between the fuel cell stack located on the most upstream side of the hydrogen gas channel and the other fuel cell stacks in the first power supply organizer and between a fuel cell stack located on the most upstream side of the hydrogen gas channel and other fuel cell stacks in the second power supply organizer, first on-off valves capable of opening and blocking the hydrogen gas channel are provided, respectively.

6. A driving method for the fuel cell system according to claim 1, the driving method comprising:
starting up the fuel cell stack connected to the oxidant gas channel on the most upstream side using the battery; and
supplying power obtained by power generation of the fuel cell stack to the air suppliers of other fuel cell stacks of the fuel cell system to cause the other fuel cell stacks to start up.

7. A driving method for the fuel cell system according to claim 2, the driving method comprising:
starting up the fuel cell stack connected to the oxidant gas channel on the most upstream side in the first power supply organizer using the battery and supplying power obtained by power generation of the fuel cell stack to the air supplier of the fuel cell stack connected to the oxidant gas channel on the most upstream side among the fuel cell stacks constituting the second power supply organizer to cause the fuel cell stack to start up.

8. A driving method for the fuel cell system according to claim 1,
the fuel cell system comprising a stack information acquirer acquiring fuel cell stack information including deterioration degree information about and/or an operation history of each of the fuel cell stacks,
the battery being electrically connected to the air suppliers provided for at least two or more of the fuel cell stacks, and the driving method comprising determining fuel cell stacks to be supplied with power from the battery, based on the deterioration degree information and/or the operation history acquired by the stack information acquirer.

9. A driving method for the fuel cell system according to claim 3,
the fuel cell system comprising a startup preparation information acquirer acquiring startup preparation completion information about the fuel cell stack connected to the oxidant gas channel on the most upstream side, and
the driving method comprising switching the first on-off valve from a blocked state to an open state of the hydrogen gas channel by acquiring the startup preparation completion information.

10. A driving method for the fuel cell system according to claim 3,
the fuel cell system comprising a power generation amount acquirer acquiring an amount of power generation of the fuel cell stack connected to the oxidant gas channel on the most upstream side, and
the driving method comprising switching the first on-off valve from a blocked state to an open state of the hydrogen gas channel when the amount of power generation satisfies a predetermined condition.

11. A driving method for the fuel cell system according to claim 4,
the fuel cell system comprising a startup preparation information acquirer acquiring startup preparation completion information about the first power supply organizer, and
the driving method comprising switching the second on-off valve from a blocked state to an open state of the hydrogen gas channel by acquiring the startup preparation completion information.
